(19) United States
(12) Patent Application Publication
(10) Pub. No.: US 2006/0110635 A1
(43) Pub. Date: May 25, 2006

(54) Fuel cell system, gas replacement method for fuel cell system, and device for fuel cell system

(75) Inventor: Shuichiro Saito, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/262,756

(22) Filed: Nov. 1, 2005

(30) Foreign Application Priority Data
Nov. 10, 2004 (JP) 2004-326802

(51) Int. Cl. H01M 8/00; H01M 2/36

(52) U.S. Cl. 429/13; 429/12; 429/72

(57) ABSTRACT

A fuel cell system is provided which includes a fuel supply part for fuel gas and a fuel flow path having a purge valve for gas discharge, wherein the fuel supply part is provided at a position upstream from a position of the purge valve in a gravity direction of the fuel cell system in use. Thereby, there are provided a fuel cell and a gas replacement method for a fuel cell that allow efficient replacement of fuel gas and suppression of waste of the fuel gas.

### BACKGROUND OF THE INVENTION

1. Field of the Invention

The present invention relates to a fuel cell system using hydrogen gas as a fuel, to a gas replacement method for a fuel cell system, and to a device for a fuel cell system. More specifically, the present invention relates to a gas replacement method for filling a fuel cell system with a fuel. In particular, the present invention relates to a gas replacement method suitable for supplying a fuel from a fuel cartridge.

2. Related Background Art

In recent years, environmental destruction has become a problem, and a clean energy which does not generate harmful waste, is required. Exhaustion of fossil fuel also becomes a problem, and a new energy source is in demand. Meanwhile, in the electronics field, the amount of information increases, with which the information processing ability is dramatically enlarged, and electric power consumption of electronic devices tends to increase.

Thus, hydrogen, which is contained in water that is inexhaustible on the earth, has a large chemical energy, and does not discharge harmful substances, attracts attention as an energy source. A fuel cell, which directly produces an electric energy, can take out a large amount of electric power with highly efficient use of hydrogen, and therefore, application to automobiles and portable electronic devices such as notebook personal computers, mobile phones, and digital camcorders is being advanced.

The so-called fuel cell, which takes out an electric energy from hydrogen, has a hydrogen electrode to which hydrogen is supplied and an oxidation electrode to which oxygen is supplied, and separates hydrogen atoms into electrons and protons by a catalytic reaction in the hydrogen electrode. The protons pass through an electrolyte membrane, then reach the oxidation electrode, and react with oxygen by a catalytic reaction, thereby generating water, and in this process, a flow of electrons, namely electric power, is generated.

Unlike the conventional batteries, with the fuel cell, there is no need of electric charge, and it is possible to generate an electric power immediately by only replenishing the fuel cell with a fuel after the fuel is used up, which is convenient for long-term use of a device.

As described above, the fuel cell can take out an electric energy by replenishing it with a fuel at any time at any place, but has to use gas such as hydrogen unlike the conventional secondary battery. On replacement of a fuel cartridge, it is necessary to remove the fuel cartridge from a fuel cell system temporarily, and on this occasion, air in the atmosphere will enter the fuel cell system. At that time, the output of the fuel cell significantly reduces, or in many cases, the reaction of the fuel cell stops. Accordingly, it is essential to replace the gas inside the fuel cell system with fuel gas at the time of fuel replacement.

Further, the gas replacement is also required when gas in air enters a fuel supply side, in addition to the time of fuel cartridge exchange.

### SUMMARY OF THE INVENTION

It is, therefore, an object of the present invention to provide a fuel cell using hydrogen gas as a fuel and allowing efficient gas replacement, and a gas replacement method for a fuel cell.

According to a first aspect of the present invention, there is provided a fuel cell system comprising a fuel cell; a fuel supply part for supplying fuel gas into the system; a fuel flow path for allowing the supplied fuel gas to flow therethrough; and a purge valve provided in the fuel flow path, for discharging gas in the system, wherein the fuel supply part is provided at a position upstream from a position of the purge valve in a gravity direction of the fuel cell system in use.

In the present invention, it is preferred that the fuel gas is supplied from the fuel supply part and the gas discharge is effected through the purge valve, thereby replacing gas in the fuel flow path.

According to a second aspect of the present invention, there is provided a device for a fuel cell system comprising a device body and a fuel cell system mounted on the device body, the fuel cell system comprising a fuel cell; a fuel supply part for supplying fuel gas into the system; a fuel flow path for allowing the supplied fuel gas to flow therethrough; and a purge valve provided in the fuel flow path, for discharging gas in the system, wherein the fuel supply part is provided at a position upstream from a position of the purge valve in a gravity direction of the device in use.

According to a third aspect of the present invention, there is provided a device for a fuel cell system comprising a device body and a cell chamber for housing a fuel cell system, the fuel cell system comprising a fuel cell; a fuel supply part for supplying fuel gas into the system; a fuel flow path for allowing the supplied fuel gas to flow therethrough; and a purge valve provided in the fuel flow path, for discharging gas in the system, wherein the cell chamber has such housing directionality as to house the fuel cell system such that the fuel supply part is provided at a position upstream from a position of the purge valve in a gravity direction of the device in use.

According to a fourth aspect of the present invention, there is provided a gas replacement method for a fuel cell comprising a fuel supply part for fuel gas and a fuel flow path having a purge valve for gas discharge, the method comprising the steps of providing the fuel supply part at a position upstream from a position of the purge valve in a gravity direction of the fuel cell in use; and supplying the fuel gas from the fuel supply part at the upper position and effecting the gas discharge through the purge valve at the lower position, thereby replacing gas in the fuel flow path.

In the present invention, it is preferred that an output voltage of the fuel cell is detected, and when the output voltage is less than a predetermined voltage, the gas in the fuel flow path is replaced for a predetermined period of time.

Further, it is preferred that an output voltage of the fuel cell is detected, and when the output voltage is less than a predetermined voltage, the gas in the fuel flow path is replaced until a predetermined output voltage is obtained.

Moreover, it is preferred that when a main switch of a device to which the fuel cell is attached is turned on, the gas in the fuel flow path is replaced for a predetermined period of time.

Further, it is preferred that when a main switch of a device to which the fuel cell is attached is turned on, the gas in the fuel flow path is replaced until a predetermined output voltage is obtained.

According to the present invention, it is possible to efficiently replace fuel gas and to suppress waste of fuel gas.

Other features and advantages of the present invention will be apparent from the following description taken in conjunction with the accompanying drawings.

### BRIEF DESCRIPTION OF THE DRAWINGS

FIG. 1 is a schematic cross-sectional view showing a fuel cell system in accordance with the present invention;

FIG. 2 is a schematic perspective view showing a fuel cell system and a fuel cartridge in accordance with the present invention;

FIG. 3 is a system diagram of a digital camera having a fuel cell system;

FIG. 4 is a flow chart explaining an operation of a fuel cell system;

FIG. 5 is a flow chart explaining another operation of a fuel cell system;

FIG. 6 is a schematic perspective view showing a digital camera in usual use in accordance with a preferred embodiment of the present invention; and

FIG. 7 is a schematic perspective view showing a notebook personal computer in usual use in accordance with a preferred embodiment of the present invention.

### DESCRIPTION OF THE PREFERRED EMBODIMENTS

With the fuel cell system, the gas replacement method for a fuel cell system, and the device for a fuel cell system in accordance with the present invention, it is possible to supply a fuel at a relatively upper position, i.e., upstream, in a gravity direction, and to discharge gas for gas replacement at a relatively lower position, i.e., downstream, in the gravity direction.

Incidentally, the term “device for fuel cell system” herein employed refers to a device that employs a fuel cell system. The fuel cell system may be built in the device, or the fuel cell system may be formed to be attachable to and detachable from the device.

Preferred embodiments of the present invention will be described with reference to the drawings.

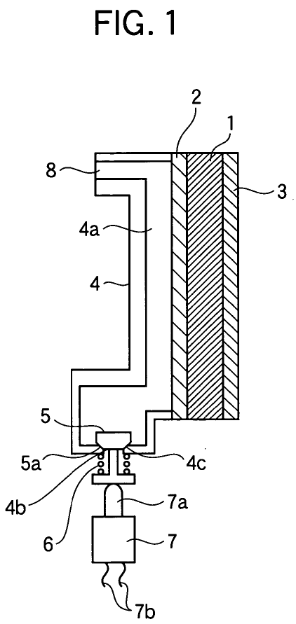

FIG. 1 is a schematic cross-sectional view showing a fuel cell system in accordance with a preferred embodiment of the present invention.

In FIG. 1, reference numeral 1 denotes a polymer electrolyte membrane. Reference numeral 2 denotes a fuel electrode, and reference numeral 3 denotes an oxygen electrode. Reference numeral 4 denotes a casing, and reference character 4a denotes a hydrogen flow path. Reference numeral 8 denotes a fuel supply part for fuel gas.

Reference numeral 5 denotes a purge valve for discharging gas in the fuel cell system for gas replacement, and a conical surface 5a is provided in contact with a conical surface 4c formed at a gas discharge portion 4b provided at the bottom of the casing 4 of the fuel cell system. Reference numeral 6 denotes a compression spring formed such that the purge valve 5 is forced in a downward direction in FIG. 1. The conical surfaces 5a and 4c are usually in contact with each other by means of the compression spring 6, to thereby prevent gas in the fuel cell system from flowing outside the system. Reference numeral 7 denotes an electromagnet. Energization of two lead wires 7b causes displacement of a plunger 7a in an upward direction in FIG. 1 against the force of the compression spring 6 to break the contact between the conical surfaces 5a and 4c, to thereby allow the gas in the fuel cell system to flow outside the system.

The fuel supply part 8 is provided at a position upstream from a position of provision of the purge valve 5 in a gravity direction of the fuel cell system when being in use. Fuel gas is supplied from the fuel supply part 8 at the upper position, and gas discharge is effected through the purge valve 5 at the lower position to replace gas in the fuel flow path 4a. In FIG. 1, an upper part of the figure corresponds to an upper position in a gravity direction, while a lower part of the figure corresponds to a lower position in the gravity direction.

The expression “fuel cell system in use” herein employed refers to a fuel cell system which is actually used for power generation. The expression “gravity direction of fuel cell system in use” herein employed refers to a direction of a gravity which acts on a fuel cell system in use. In a case where a fuel cell system is used at various orientations, the term “gravity direction” refers to a direction of a gravity which acts on a fuel cell system when being in a substantially dominant orientation.

A general operation of a fuel cell system will be described. As is well known and shown in the following reaction formula, hydrogen is ionized into hydrogen ions and electrons by a platinum catalyst of a hydrogen electrode.
H₂→2H⁺+2e⁻

The hydrogen ions pass through an electrolyte membrane and transfer to an oxygen electrode side.

In an oxygen electrode, as shown in the following reaction formula, oxygen derived from air and the hydrogen ions that passed through the electrolyte membrane react with each other by means of a platinum catalyst to produce water.
2H⁺+1/2O₂+2e⁻→H₂O

The electrons transfer through an external circuit, whereby electrical energy can be obtained.

Hydrogen is supplied from an upper part of a hydrogen flow path, and the purge valve 5 for discharging gas other than hydrogen in the hydrogen flow path and filling the hydrogen flow path with the hydrogen gas is provided at a lower part of the hydrogen flow path.

Since hydrogen is lighter than any other gas, other gas than hydrogen accumulate at a lower part of the hydrogen flow path and are easily discharged outside of the hydrogen flow path by opening of the purge valve 5.

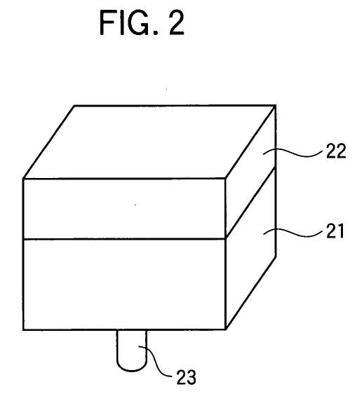

FIG. 2 is a schematic perspective view showing a state in which a fuel cell system 21 and a fuel cartridge 22 are connected to each other. The fuel cell system 21 is built in a portable electronic device such as a digital camera as is the case with this embodiment. The fuel cartridge 22 can be inserted from outside of the digital camera. The fuel cartridge 22 may be filled with compressed hydrogen, or may have a structure allowing storage of hydrogen in a hydrogen storage alloy such as an Fe—Ti alloy or a Ti—Mn alloy.

Reference numeral 23 denotes a purge valve provided in a lower part.

In FIG. 2, an upper part of the figure corresponds to an upper position in a gravity direction, while a lower part of the figure corresponds to a lower position in the gravity direction.

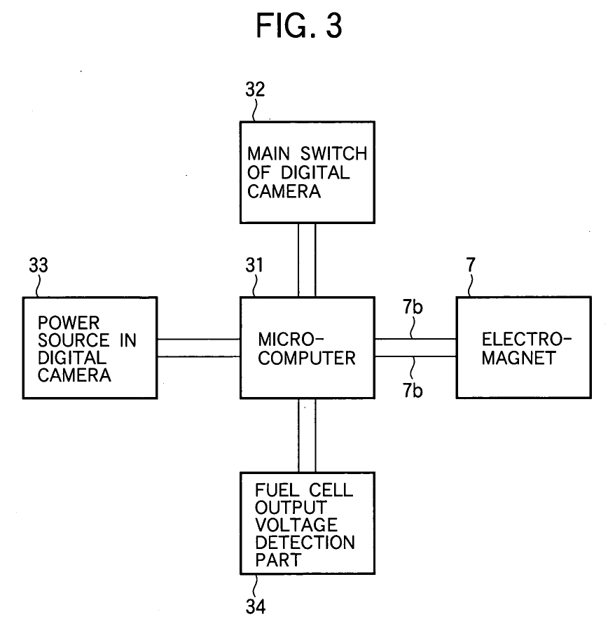

FIG. 3 is a system diagram of a digital camera having a fuel cell system. In FIG. 3, reference numeral 7 denotes the electromagnet shown in FIG. 1.

In the figure, reference numeral 31 denotes a microcomputer in a device provided with a fuel cell system such as a digital camera in this embodiment. Reference numeral 32 denotes a main switch of the digital camera. Reference numeral 33 denotes a power source in the digital camera used for activation of the fuel cell or the like. Reference numeral 34 represents a fuel cell output voltage detection part.

Next, the operation will be described.

When a fuel cartridge is attached, atmospheric air enters from a hydrogen supply part. In this state, a reaction of the fuel cell is inhibited. The microcomputer 31 energizes the electromagnet 7 for a predetermined period of time to open the purge valve, so that gas in the fuel cell system is discharged out of the system to reduce the internal pressure to allow supply of fuel gas from a fuel cartridge. As a result, the gas in the fuel cell system is replaced by the fuel gas. At this time, it is to be noted that unless the gas pressure inside the fuel cell system is higher than the atmospheric pressure, gas replacement will not occur and the atmosphere will enter the system instead. Thus, in the present invention, the gas pressure inside the fuel cell system necessarily needs to be set higher than the peripheral atmospheric pressure.

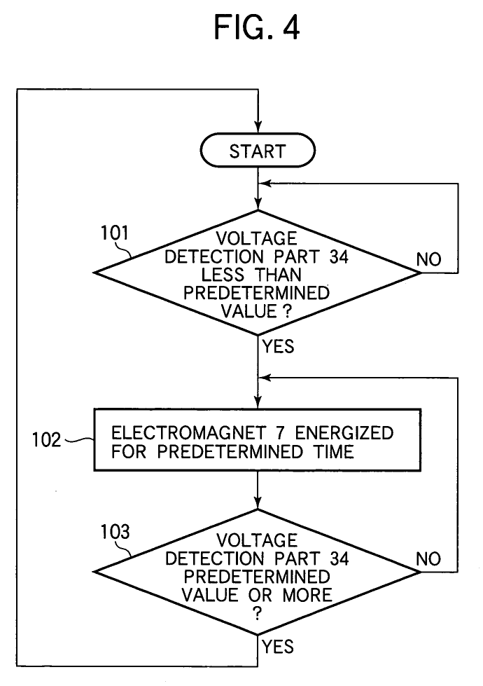

FIG. 4 is a flow chart explaining an embodiment for controlling purge by utilizing an output of a fuel cell.

The fuel cell output voltage detection part 34 detects a voltage (101). When the voltage is less than a predetermined voltage, it is judged that gas replacement is insufficient, so that the electromagnet 7 is energized for a predetermined period of time (102), and the purge valve is opened to effect gas replacement. When it is detected that the voltage is a predetermined voltage or more (103), the series of operation is finished, and the operation returns to start and continues in the flow chart.

Next, another embodiment of the present invention will be described.

In a digital camera in accordance with another embodiment of the present invention, whenever a main switch 32 of a digital camera is turned on, an electromagnet 7 is energized for a predetermined period of time to open a purge valve 5 thereby effecting gas replacement. A fuel cell output voltage detection part 34 detects a voltage when the main switch 32 is in an on state, and when a detected voltage becomes less than a predetermined voltage, the purge valve is opened for a predetermined period of time to effect gas replacement. Alternatively, the purge valve 5 is opened until a voltage detected by the fuel cell output voltage detection part 34 reaches a predetermined voltage.

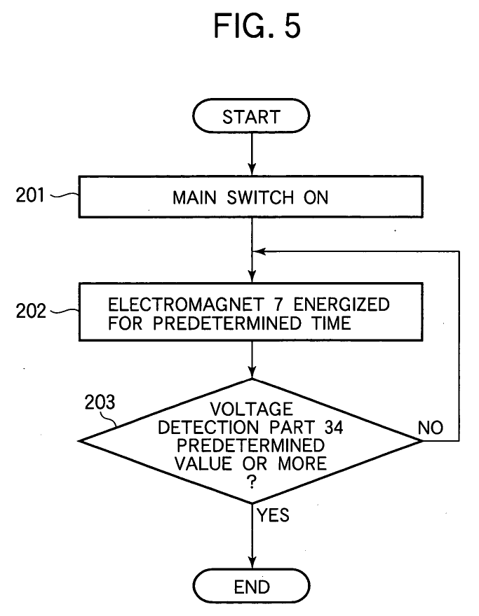

FIG. 5 is a flow chart for explanation. The explanation will be made based on the flow chart.

When a digital camera is in operation, a fuel cell output voltage detection part 34 detects a voltage at all times or at predetermined time intervals and judges whether or not the voltage is a predetermined voltage or more (203). When the detected voltage is the predetermined voltage or more, the voltage detection is continued. When the detected voltage is less than the predetermined voltage, the program proceeds to a next step and an electromagnet 7 is energized for a predetermined period of time (202) to open a purge valve thereby effecting gas replacement. Then, the fuel cell output voltage detection part 34 detects the voltage and judges whether or not the voltage is a predetermined voltage or more (203). When the detected voltage is less than the predetermined voltage, it is indicated that gas replacement is insufficient, so that the program returns to step (202), where the electromagnet 7 is energized for a predetermined period of time to effect gas replacement. Then, the fuel cell output voltage detection part 34 detects the voltage and judges whether or not the voltage is a predetermined voltage or more (203). In a case where the voltage is the predetermined voltage or more, the program returns to the start and the same procedure is repeated. Thus, the fuel cell can be stably operated without a special operation by a user.

Next, still another embodiment of the present invention will be described.

According to still another embodiment of the present invention, a fuel cell operates normally without requiring the user's attention. In this embodiment, detection of a fuel cell output voltage does not need to be necessarily performed, and an electromagnet 7 may be energized for a predetermined period of time.

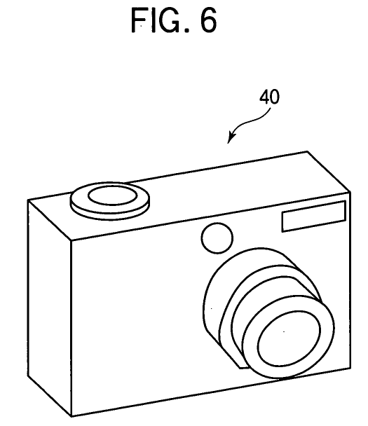

FIG. 6 is a schematic perspective view showing a digital camera in usual use in which a fuel cell system of the present invention is used. In FIG. 6, an upper part of the figure corresponds to an upper position in a gravity direction, and a lower part of the figure corresponds to a lower position in the gravity direction. In this state, a purge valve is provided at a relatively lower position in the gravity direction of the fuel cell system, and a fuel supply part is provided at a relatively upper position in the gravity direction.

The electronic devices include those which are used in various orientations such as a digital camera. The digital camera is used at various orientations such as a horizontal orientation or a vertical orientation depending on a composition of a captured image. In such a case, the gravity direction refers to a direction of gravity which acts on the camera in an orientation in usual use. In the gravity direction thus determined, a fuel supply part and a purge valve may be provided in a fuel cell system, or a fuel cell system may be mounted on the digital camera such that the fuel supply part is provided at a position upstream from a position of the purge valve. FIG. 6 may be referred to as an example of a case where a fuel cell system is mounted on an electronic device that is used in various orientations.

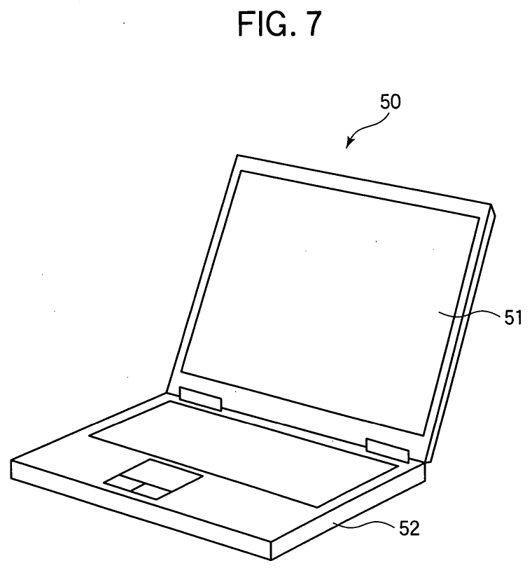

FIG. 7 is a schematic perspective view showing a notebook personal computer in usual use in which a fuel cell system of the present invention is used. In FIG. 7, an upper part of the figure corresponds to an upper position in a gravity direction, and a lower part of the figure corresponds to a lower position in the gravity direction. In this state, the purge valve is provided at a relatively lower position of the fuel cell system.

The notebook personal computer as shown in FIG. 7 is generally used at an orientation such that a main body portion 52 is placed on a desk or table and a display portion (cover portion) 51 serving as a protective cover for an operation part such as a keyboard and also as an image display part such as a liquid crystal screen is opened upwardly. Accordingly, the gravity direction in this case refers to a direction of gravity acting on the notebook personal computer at this orientation. A fuel supply part and a purge valve may be provided in a fuel cell system, or a fuel cell system may be mounted on the notebook personal computer such that the fuel supply part is provided at a position upstream from a position of provision of the purge valve in that gravity direction.

As shown in FIGS. 6 and 7, the fuel supply part and the purge valve may be provided in the fuel cell system in use such that the fuel supply part is provided at a position upstream from a position of provision of the purge valve in the gravity direction according to the device having the fuel cell system in usual use. Alternatively, the fuel cell may be mounted on the device such that the fuel supply part is provided at an upper position with respect to a position of provision of the purge valve in the gravity direction.

The embodiments shown in FIGS. 6 and 7 are examples for purposes of illustration only and not intended to be limiting of the present invention. Incidentally, in the electronic device employing the fuel cell system, the fuel cell system may be built in, or the fuel cell system may be formed to be attachable to and detachable from the device.

When the fuel cell system is built in the electronic device, the fuel supply part may be provided at a position upstream from a position of provision of the purge valve in a gravity direction of the device in use.

When forming the fuel cell system so as to be attachable to and detachable from the device, a cell chamber for housing the fuel cell system may be so designed as to ensure that the fuel cell system is housed therein in a predetermined orientation, so that the fuel supply part is located at a position upstream from a position of provision of the purge valve in a gravity direction of the device in use. Specifically, for example, the cell chamber may be formed into such a shape as to ensure that the fuel cell system is housed therein in a predetermined orientation, thereby providing a housing directionality to the cell chamber.

The present invention allows efficient fuel gas replacement and suppression of waste of fuel gas and can therefore be suitably utilized for a small electronic device such as a digital still camera, a digital camcorder, a mobile phone, or a notebook personal computer.

This application claims priority from Japanese Patent Application No. 2004-326802 filed on Nov. 10, 2004, which is hereby incorporated by reference herein.

1. A fuel cell system comprising:
a fuel cell;
a fuel supply part for supplying fuel gas into the system;
a fuel flow path for allowing the supplied fuel gas to flow therethrough; and
a purge valve provided in the fuel flow path, for discharging gas in the system,
wherein the fuel supply part is provided at a position upstream from a position of the purge valve in a gravity direction of the fuel cell system in use.

2. The fuel cell system according to claim 1, wherein the fuel gas is supplied from the fuel supply part and the gas discharge is effected through the purge valve, thereby replacing gas in the fuel flow path.

3. A device for a fuel cell system comprising:
a device body; and
a fuel cell system mounted on the device body, the fuel cell system comprising:
a fuel cell;
a fuel supply part for supplying the fuel gas into the system;
a fuel flow path for allowing the supplied fuel gas to flow therethrough; and
a purge valve provided in the fuel flow path, for discharging gas in the system,
wherein the fuel supply part is provided at a position upstream from a position of the purge valve in a gravity direction of the device in use.

4. A device for a fuel cell system comprising:
a device body; and
a cell chamber for housing a fuel cell system, the fuel cell system comprising:
a fuel cell;
a fuel supply part for supplying fuel gas into the system;
a fuel flow path for allowing the supplied fuel gas to flow therethrough; and
a purge valve provided in the fuel flow path, for discharging gas in the system,
wherein the cell chamber has such housing directionality as to house the fuel cell system such that the fuel supply part is provided at a position upstream from a position of the purge valve in a gravity direction of the device in use.

5. A gas replacement method for a fuel cell comprising a fuel supply part for fuel gas and a fuel flow path having a purge valve for gas discharge, the method comprising the steps of:
providing the fuel supply part at a position upstream from a position of the purge valve in a gravity direction of the fuel cell in use; and
supplying the fuel gas from the fuel supply part at the upstream position and effecting the gas discharge through the purge valve at the lower position, thereby replacing gas in the fuel flow path.

6. The gas replacement method for a fuel cell according to claim 5, wherein an output voltage of the fuel cell is detected, and when the output voltage is less than a predetermined voltage, the gas in the fuel flow path is replaced for a predetermined period of time.

7. The gas replacement method for a fuel cell according to claim 5, wherein an output voltage of the fuel cell is detected, and when the output voltage is less than a predetermined voltage, the gas in the fuel flow path is replaced until a predetermined output voltage is obtained.

8. The gas replacement method for a fuel cell according to claim 5, wherein when a main switch of a device to which the fuel cell is attached is turned on, the gas in the fuel flow path is replaced for a predetermined period of time.

9. The gas replacement method for a fuel cell according to claim 5, wherein when a main switch of a device to which the fuel cell is attached is turned on, the gas in the fuel flow path is replaced until a predetermined output voltage is obtained.
